(19) United States
(12) Patent Application Publication
(10) Pub. No.: US 2013/0323364 A1
(43) Pub. Date: Dec. 5, 2013

(54) PREMIX FOR A FORTIFIED FOOD BLEND

(71) Applicants: Georg Steiger, Kaiseraugst (CH); Hugo Streekstra, Delft (NL); Karin Wertz, Kaiseraugst (CH)

(72) Inventors: Georg Steiger, Kaiseraugst (CH); Hugo Streekstra, Delft (NL); Karin Wertz, Kaiseraugst (CH)

(73) Assignee: DSM IP ASSETS B.V., HEERLEN (NL)

(21) Appl. No.: 13/983,881

(22) PCT Filed: Feb. 21, 2012
(86) PCT No.: PCT/EP12/52899

§ 371 Date: Aug. 6, 2013

Related U.S. Application Data
(60) Provisional application No. 61/457,309, filed on Feb. 22, 2011.

(30) Foreign Application Priority Data
May 3, 2011 (EP) 11164664.2

(51) Int. Cl. A23L 1/10

(52) U.S. Cl. CPC A23L 1/1008
USPC 426/64

(57) ABSTRACT

The present invention relates to a vitamin, mineral and enzyme premix for a fortified food blend comprising an alpha-amylase and a glucoamylase to increase energy content, reduce viscosity, and improve taste of a porridge prepared from said fortified food blend. Furthermore, the invention relates to a high energy fortified food blend comprising a vitamin, mineral and enzyme pre-mix from which a high energy, low viscosity and tasty porridge can be prepared. It also relates to a porridge prepared form the fortified food blend according to the present invention.

The present invention relates to a vitamin, mineral and enzyme premix for a fortified food blend comprising an alpha-amylase and a glucoamylase to increase energy content, reduce viscosity, and improve taste/palatability of a porridge prepared from said fortified food blend. Furthermore, the invention relates to a high energy fortified food blend comprising a vitamin, mineral and enzyme premix from which a high energy, low viscosity and tasty porridge can be prepared. It also relates to a porridge prepared form the fortified food blend according to the present invention.

Between six and twelve months of age, the average energy requirements of children are 98 kcal/kg per day, and then rises to 102 kcal/kg per day during the second and third year of life (FAO/WHO/UNU 1985). The AAP (American Academy of Pediatrics) recommends that children age 1 to 3 years get about 40 calories per inch of height a day, which corresponds in general with the average statement given above. In addition, median intake of water/liquids from drinks is about 820 ml/day (Forschungsinstitut für Kinderernährung, 2005).

Specific toddler complementary foods are known in the art. Enfamil Premium 3 for toddlers is a milk-based toddler beverage made especially to ensure proper nutrition to grow up healthy and strong whatever basic food is given or where feeding may be a challenge. The product offers 13 vitamins and minerals, essential fatty acids and DHA. Furthermore, it is enriched in iron and source of calcium. The recommended dosing level of this product is 2 servings of 260 ml per day providing 172 kcal per serving.

The food basket of non-governmental organizations NGOs comprise flour, pulses, oil, sugar and similar, and is complemented by fortified food blends, such as corn soya blend or wheat soya blend. These blends are fortified with vitamins and minerals to prevent or treat hidden hunger.

Fortified food blends are blends of milled carbohydrate-rich crops such as corn, wheat, sorghum, millet and the like, and milled protein-rich legumes such as soy, chick peas, lentils beans and the like. These blends are fortified with essential vitamins and minerals. Today, corn soya blend (CSB) is the most important complementary food product in food aid provided to populations in need of in developing world. It is provided to children of 6 months of age and up. Satisfying the nutritional needs of infants during the first 1000 days of life are considered to be crucial in terms of allowing a child to realize his/her genetic potential for future lifelong professional performance. If a child is malnourished during this period, his/her brain and cognitive development will be suboptimal, thus limiting his/her future professional perspective.

Today, corn soya blend (CSB) is the most important complementary food product in food aid. It is provided as porridge to humans in need from the age of 6 months and up (toddlers) in rations of currently up to 200 g/d. However, current CSB is limited in its nutritional benefit for several reasons:

Firstly, the current CSB gives rise to a porridge with a high viscosity, thus limiting the % CSB which can be used to prepare a porridge, especially a porridge suitable for swallowing by small children, but also HIV patients and other people having difficulty to swallow a high viscosity meal.

Thus, the current porridge viscosity limits the achievable energy density of the porridge. The current energy density means that a toddler has to eat 1.8 L porridge per day to consume its energy needs of approximately 1000 kcal (realistic: 5×200 mL/d). Children currently are hardly able to eat an entire portion (290 mL), thus the remainder of the portion is being kept. As a result, children do not get enough calories, and thus do not grow optimally. Moreover, keeping the prepared porridge at ambient temperature in tropical countries risks microbial growth in porridge, leading to diarrhea in the consumers including children. Diarrhea in turn leads to disturbed food intake and digestion, thus further limiting energy intake and child development.

Secondly, the slightly bitter and otherwise relatively neutral taste limits the acceptability of the porridge by consumers including children, hence also has a bearing for the energy intake by toddlers.

There are few other very successful tasty food products with high energy density to treat malnutrition, like peanut-based ready to use therapeutic food.

However, available funding is not sufficient to provide such products to all children in need. Also, a more balanced nutrient profile would be desirable in terms of calories provided from fat versus from carbohydrates.

Hence for fighting macronutrient malnutrition, there is a need for a cost effective and tasty fortified food blend porridge with a high energy density and a low density.

The inventors of the present application now surprisingly found that a vitamin, mineral and enzyme premix comprising a specific enzyme composition allows the preparation of a tasty porridge, wherein the energy density of the porridge is greater than 800 kcal/l, and the viscosity at 45° C., as measured in a Bostwick test, is greater than 10 cm/30″. This premix firstly solves the problem of the taste of the resulting porridge which is much improved compared to a porridge prepared without enzymes because of the release of glucose. Secondly, it also solves the problem of the energy density and viscosity of porridges prepared form fortified food blends of the prior art which are not compatible with infant nutrition because of the low energy density at an acceptable viscosity. Thirdly, the premix according to the present invention allows generating a fortified food blend suitable for infant nutrition without significantly increasing the production cost of the fortified food blend. The unique enzyme selection of the present invention comprising an alpha-amylase, and a glucoamylase in a specific ratio, results from a unique selection of enzymes which are able to express sufficient enzymatic activity during the defined cooking time of the porridge—which is quite variable depending on the individual cooking habits—, but also are completely inactivated by the end of the porridge cooking process, thereby making the porridge fully compatible with the enzyme regulatory constraints.

The vitamin mineral and enzyme premix according to the present invention is unique in the sense that it allows a very robust porridge preparation, consistently leading to improved viscosity, improved energy density, improved glucose content and taste, and resulting in the absence of enzymatic activity at the end of the cooking process.

Therefore, in a first embodiment, the invention relates to a vitamin, mineral and enzyme premix for a fortified food blend comprising at least an alpha-amylase and a glucoamylase, wherein the alpha-amylase/glucoamylase enzyme unit ratio is comprised between 1/2 and 1/75.

Alpha-amylases belong to the group of enzymes E.C. 3.2.1.1., and are characterized by the fact that they are endo-acting starch degrading enzymes. Preferred alpha-amylases according to the present invention are “Bacterial Amylase 51400”, “Fungal Amylase 11500” which both can be purchased from DSM Food Specialties; Delft; NL, and BAN800 from Novozymes Corp. based on their ability to reduce viscosity during preparation of the porridge, and their ability to be degraded at the end of the cooking time.

Glucoamylases belong to the group of enzymes E.C. 3.2.1.3., and are characterized by the fact that they are exo-acting starch degrading enzymes. Preferred glucoamylases are Glucoamylase 65000 which can be purchased from DSM Food Specialties; Delft; NL, and AMG800 from Novozymes Corp. based on their ability to liberate free glucose and improve taste of the porridge, but also to be degraded at the end of the cooking time.

In another embodiment, the fortified food blend according to the present invention is a blend of milled carbohydrate-rich crops such as corn, wheat, sorghum, millet and the like, and milled protein-rich legumes such as soy, chick peas, lentils beans and the like. Preferred fortified food blend according to the present invention are corn soya blend and wheat soya blend. Most preferred is wheat soya blend.

In another embodiment, the vitamin, mineral and enzyme premix of the present invention comprises a mixture of alpha-amylase and glucoamylase in a weight ratio comprised between 1/1 and 1/50, preferably comprised between 1/5 and 1/30, more preferably comprised between 1/8 and 1/20.

More accurately, the amount and ratio of specific enzyme added to the premix, can be defined by the number of units of each specific enzyme. A convenient unit to express the activity of alpha-amylases is the RAU. 1 RAU is defined as the quantity of enzyme that converts under standardized conditions (pH=6.6, 30° C.) 1 mg soluble starch per minute, having an equal absorption to a reference colour at 620 nm after reaction with Iodine. Therefore, alpha-amylase activity will be defined throughout the invention as RAU units.

A convenient unit to express the activity of Glucoamylases is the AGU. 1 AGU is defined as the quantity of enzyme which produces 1 μmole of glucose per minute at pH 4.3 and at a temperature of 60° C. from a soluble starch substrate. Therefore, glucoamylase activity will be defined throughout the invention as AGU units.

Therefore, in another embodiment, the vitamin, mineral and enzyme premix of the present invention comprises a mixture of alpha-amylase and glucoamylase in a unit ratio preferably comprised between 1/10 and 1/50, most preferably comprised between 1/15 and 1/35.

In another embodiment, the vitamin, mineral and enzyme premix of the present invention comprises a total amount (sum of the weight of both enzymes) comprised between 300 and 700 g of alpha-amylase and glucoamylase per kilogram of premix. More preferably, it comprises between 400 and 600 g of alpha-amylase and glucoamylase per kilogram of premix.

In another embodiment, the vitamin, mineral and enzyme premix of the present invention comprises between 1000 and 5000 alpha-amylase units and between 10000 and 150000 glucoamylase units per kg premix. Preferably, the premix comprises between 1500 and 4000, more preferably between 2000 and 3500 alpha-amylase units, and preferably, between 30000 and 110000, more preferably between 40000 and 80000 glucoamylase units per kg premix.

In another embodiment, the vitamin, mineral and enzyme premix of the present invention comprises a total amount (sum of the weight of both enzymes) comprised between 300 and 700 g of alpha-amylase and glucoamylase per kilogram of premix, and the unit ratio of alpha-amylase/glucoamylase is comprised between 1/2 and 1/75.

### Definitions

Malnutrition is the condition that results from taking an unbalanced diet in which certain nutrients are lacking, in excess (too high an intake), or in the wrong proportions. A number of different nutrition disorders may arise, depending on which nutrients are under- or over-abundant in the diet. The World Health Organization cites malnutrition as the gravest single threat to the world's public health. Improving nutrition is widely regarded as the most effective form of aid. Emergency measures include providing deficient micronutrients through fortified sachet powders, such as peanut butter, or directly through supplements. The famine relief model increasingly used by aid groups calls for giving cash or cash vouchers to the hungry to pay local farmers instead of buying food from donor countries, often required by law, as it wastes money on transport costs. Long term measures include investing in modern agriculture in places that lack them, such as fertilizers and irrigation, which largely eradicated hunger in the developed world. However, World Bank strictures restrict government subsidies for farmers and the spread of fertilizer use is hampered by some environmental groups.

A nutrient is a chemical that an organism needs to live and grow or a substance used in an organism's metabolism which must be taken in from its environment. Nutrients are the substances that enrich the body. They are used to build and repair tissues, regulate body processes and converted to and used as energy. Organic nutrients include carbohydrates, fats, proteins (or their building blocks, amino acids), and vitamins. Inorganic chemical compounds such as dietary minerals, water, and oxygen may also be considered nutrients. A nutrient is said to be “essential” if it must be obtained from an external source, either because the organism cannot synthesize it or produces insufficient quantities.

Nutrients needed in very small amounts are micronutrients and those that are needed in larger quantities are called macronutrients. The effects of nutrients are dose-dependent and shortages are called deficiencies.

An inadequate amount of a nutrient is a deficiency. Deficiencies can be due to a number of causes including inadequacy in nutrient intake called dietary deficiency, or conditions that interfere with the utilization of a nutrient within an organism. Some of the conditions that can interfere with nutrient utilization include problems with nutrient absorption, substances that cause a greater than normal need for a nutrient, conditions that cause nutrient destruction, and conditions that cause greater nutrient excretion.

Hidden hunger is unlike the hunger that comes from a lack of food. It is a chronic lack of vitamins and minerals that often has no visible warning signs, so that people who suffer from it may not even be aware of it. Its consequences are nevertheless disastrous: hidden hunger can lead to mental impairment, poor health and productivity, or even death. One in three people in the world suffer from hidden hunger. Women and children from the lower income groups in developing countries are often the most affected.

Tasty means savory or delicious.

Energy-rich means an minimum energy density of the porridge of no less than 800 kcal/L porridge.

Viscosity is a measure of the resistance of a fluid which is being deformed by either shear stress or tensile stress. In everyday terms (and for fluids only), viscosity is “thickness” or “internal friction”. Thus, water is “thin”, having a lower viscosity, while honey is “thick”, having a higher viscosity. In other words, the less viscous the fluid is, the greater its ease of movement (fluidity).

Viscosity of food stuff is typically measured at a given temperature by the Bostwick Consistometer known to the person skilled in the art (P. Perona, 2005, Applied Rheology 15: 218-229). The normal way to use the Consistometer is to measure the distance a sample flows in a given time interval.

In another embodiment, the present invention provides the use of a premix according the present invention in a fortified food blend for the preparation of porridge, wherein the energy density of the porridge is greater than 800 kcal/l, and the viscosity at 45° C., as measured in a Bostwick test is greater than 10 cm/30″.

In yet another embodiment, the present invention provides a fortified food blend comprising a premix according to the present invention for the preparation of a tasty porridge, wherein the energy density of the porridge is greater than 800 kcal/l, and the viscosity at 45° C., as measured in a Bostwick test, is greater than 10 cm/30″. Preferably the density of the porridge is greater than 1000 kcal/l, more preferably it is greater than 1200 kcal/l.

The present invention also provides a porridge prepared from a fortified food blend, according to the present invention, wherein the energy density of the porridge is greater than 800 kcal/l, and the viscosity at 45° C., as measured in a Bostwick test, is greater than 10 cm/30″.

A typical corn soya blend composition according to the present invention has the following composition:

| N^{o} | Ingredients | Percentage (by weight) |
|---|---|---|
| 1 | Corn (maize white or yellow) | 80 |
| 2 | Whole soya beans | 20 |

A typical fortified corn soya blend composition (CSB Plus) according to the present invention has the following composition:

| N^{o} | Ingredients | Percentage (by weight) |
|---|---|---|
| 1 | Corn (maize white or yellow) | 78.24 |
| 2 | Whole soya beans | 20 |
| 3 | Vitamin/Mineral premix | 0.20 |
| 4 | Ca(H₂PO₄)₂•H2O (mono | 0.80 |
| | calcium phosphate) | |
| 5 | KCl (potassium chloride) | 0.76 |

A typical fortified corn soya blend composition recommended for infants aged 6 months or more (CSB Plus Plus) according to the present invention has the following composition:

| N^{o} | Ingredients | Percentage (by weight) |
|---|---|---|
| 1 | Corn (maize white or yellow) | 58.24 |
| 2 | De-hulled soya beans | 20 |
| 3 | Dried skim milk powder | 8 |
| 4 | Sugar | 9 |
| 5 | Refined soya bean oil | 3 |
| 6 | Vitamin/Mineral premix | 0.20 |
| 7 | Ca(H₂PO₄)₂•H2O (mono | 0.80 |
| | calcium phosphate) | |
| 8 | KCl (potassium chloride) | 0.76 |

A typical vitamin and mineral premix as used in the present invention has the following composition:

| | Target | | Chemical forms |
|---|---|---|---|
| Vitamin/Mineral premix | | | |
| Vitamin A | 1,664 | IU | Dry vitamin A palmitate 250 n.s |
| Thiamine | 0.128 | mg | Thiamine mononitrate |
| Riboflavin | 0.448 | mg | Riboflavin |
| Niacin | 4.8 | mg | Nicotinamide |
| Pantothenic acid | 6.7 | mg | Calcium d-pantothenate |
| Vitamin B6 | 1.7 | mg | Pyridoxine hydrochloride |
| Folate | 60 | mcg | Folic acid |
| Vitamin B12 | 2 | mcg | Vitamin B12 - 0.1% spray dried |
| Vitamin C | 100 | mg | Ascorbic acid |
| Vitamin D | 4 | mcg | Dry vitamin D3 100 CWS |
| Vitamin E | 8.3 | mg | Vitamin E 50% CWS |
| Vitamin K | 100 | mcg | vitamin K1 5% CWS |
| Iron (a) | 4 | mg | Ferrous fumarate |
| Iron (b) | 2.5 | mg | Iron-sodium EDTA |
| Zinc | 5 | mg | Zinc oxide |
| Iodine | 40 | mcg | Potassium iodate (KIO3) |
| Carrier | qs | | Malto dextrin |
| Other minerals | | | |
| Potassium | 400 | mg | Potassium chloride (KCl) |
| Phosphorus | 200 | mg | Mono calcium phosphate |
| +Calcium | 130 | mg | Ca(H₂PO₄)₂•H2O |

Typical preparation of a porridge is as follows:

The corn soya blend (CSB) powder is mixed with water at room temperature. Recommended content is 13.8 wt-% CSB powder. The mixture is then heated to boiling temperature, and then boiled for 5 minutes before being consumed at temperatures between 35 to 45° C.

The invention is further illustrated by the following examples.

### EXAMPLES

### Example 1

### Preparation and Viscosity Determination of CSB++ Porridges

The corn soya blend (CSB++) powder was mixed with demineralized water at room temperature (proportions specified below for each example). When appropriate, enzymes were also added to the cold mixture. A suitable portion of the cold porridge was introduced into a Physica MCR 301 rheometer (Anton Paar, Austria), using cell C-PTD200-SN80585312 and cylinder CC27-SN18083. The porridge was heated in the rheometer with a temperature profile intended to mimic a normal cooking process, as indicated in the following table:

Cooking Profile in Rheometer

| | Temperature | Shear rate | Time |
|---|---|---|---|
| Step | [° C.] | [S⁻¹] | [min] |
| 1 | 20 | 100 | 2 |
| 2 | 20 → 96 | 100 | 10 or 20 |
| 3 | 96 | 100 | 5 |
| 4 | 45 | 100 | 10 |
| 5 | 45 | 1 | 20 |

The viscosity was monitored continuously during the temperature profile.

In certain cases, the level of free glucose was also measured. The glucose content was measured by HPLC, using the Agilent 1200 series (Agilent Technologies Inc., USA). The samples were first centrifuged at 20,000 g using a Centrifuge 5417C (Eppendorf, USA) for 5 minutes and the supernatant fraction was collected. If necessary, the supernatants were heated at 99° C. for 10 minutes to inactivate the enzyme. The supernatant was then filtered using a 10 kDa membrane to remove large molecules. Finally, the filtrate was diluted to a glucose concentration below 1 mg/ml (estimated) and filled into the HPLC vessels for determination of the glucose level.

### Example 2

### Action of Enzymes at Constant Temperature

The preparation of corn soya blend (CSB ++) porridge is usually done by mixing the powder with cold water, then heating it to boiling temperature, and then boil for 5 minutes (see Example 1). In the present example, however, the porridge was kept at a constant temperature which was considered optimal for enzyme activity, to be able to determine the maximal effect that may be expected from a certain enzyme dosage. This is compared to a blank porridge prepared according to the method of Example 1.

CSB++ 13.8%

| | | | | | Final | |
|---|---|---|---|---|---|---|
| | Dosage | Temp. | Time | | viscosi- | glucose |
| | (mg/g) | (° C.) | (min) | pH | ty Pa · s | (mg/g) |
| Blank | | See Ex- | | | 3 | |
| | | ample 1 | | | | |
| Bacterial Amylase | 0.1 | 70 | 20 | 6.5 | 0.012 | 0.10 |
| 51400 | | | | | | |
| Bakezyme P500 | 0.1 | 50 | 20 | 6.5 | 0.11 | 0.10 |
| Glucoamylase 65000 | 0.1 | 60 | 10 | 4 | | 3.62 |
| Glucoamylase 65000 | 1 | 60 | 10 | 4 | | 12.04 |
| Glucoamylase 65000 | 10 | 60 | 10 | 4 | | 33.24 |

It can be seen that the amylases Bacterial Amylase 51400 and Bakezyme P500 effectively reduced the final viscosity of the porridge, whereas the amyloglucosidase Glucoamylase 65000 was able to liberate free glucose.

In this example and all following examples, the specific activity of the enzymes used are as follows:

Bacterial Amylase 51400: specific activity of 51400 RAU/g,

Bakezyme P500: specific activity of 11500 FAU/g,

Glucoamylase 65000: specific activity of 65000 AGU/g.

The enzyme units are defined as follows:

Bacterial Amylase: 1 RAU is defined as the quantity of enzyme that converts under standardized conditions (pH=6.6, 30° C.) 1 mg soluble starch per minute, having an equal absorption to a reference colour at 620 nm after reaction with Iodine.

Glucoamylase: 1 AGU is defined as the quantity of enzyme which produces 1 μmole of glucose per minute at pH 4.3 and at a temperature of 60° C. from a soluble starch substrate.

Fungal Amylase (Bakezyme P500): 1 FAU is the amount of enzyme that converts 1 gram soluble starch per hour in a product having an equal absorption to a reference colour at 620 nm after reaction with iodine at pH 5.0 and 30° C. and a reaction time between 15-25 minutes.

### Example 3

### Preparation of CSB++ with Amylases

CSB++ was prepared as described previously using 40 g CSB++ powder in 250 ml water. Amylase enzymes were added to the cold porridge, at the dosage levels indicated in the table, and the 20′ heating profile was used.

CSB++ 13.8%

| | | viscosity end | Viscosity at | |
|---|---|---|---|---|
| | Enzyme | of boiling | consumption | glucose |
| | (mg/g) | (Pa · s) | (Pa · s) | (mg/g) |
| Blank | | 0.070 | 3.000 | 0.063 |
| Bacterial Amylase 51400 | 0.02 | 0.009 | 0.500 | nd |
| | 0.1 | 0.006 | 0.090 | 0.118 |
| | 1 | 0.006 | 0.030 | 0.578 |
| Bakezyme P500 | 0.02 | 0.020 | 0.500 | nd |
| | 0.1 | 0.009 | 0.200 | 0.128 |
| | 1 | 0.004 | 0.110 | 0.372 |

It is clear that the amylases reduced the viscosity of the CSB++ porridge in a dose-dependent manner. There was some release of free glucose, but not to a very large extent.

### Example 4

### Synergy Between Amylases in CSB++

The amylases used in the previous example have different temperature profiles, the Bacterial amylase being more thermostable than the Bakezyme P500. In this experiment it was explored whether there was a synergistic effect of combining amylases with different T-profiles.

CSB++ 13.8%
20′ profile

| | | viscosity | | |
|---|---|---|---|---|
| | | end | Viscosity at | |
| | Enzyme | of boiling | consumption | glucose |
| | mg/g | (Pa · s) | (Pa · s) | (mg/g) |
| Blank | | 0.070 | 3.000 | 0.063 |
| Bacterial Amylase 51400 | 0.02 | 0.009 | 0.500 | 0.099 |
| Bakezyme P500 | 0.02 | 0.020 | 0.500 | 0.106 |
| Bacterial Amylase 51400 + | 0.01 + | 0.090 | 0.300 | 0.111 |
| Bakezyme P500 | 0.01 | | | |

It was found that there was a clear synergistic effect of combining the amylase enzymes, lowering the viscosity at the consumption temperature. There was some release of free glucose, but not to a very large extent.

### Example 5

### Preparation and Viscosity Determination of CSB+ Porridges

The CSB+ powder was mixed with demineralized water at room temperature (proportions specified below for each example). When appropriate, enzymes were also added to the cold mixture. As we intended to increase the CSB concentration in a number of Examples, the preparation was performed in equipment capable of handling higher viscosity levels. A suitable portion of the cold porridge was introduced into a Rapid Visco Analyzer (Perten Instruments, Germany).

The porridge was heated in the RVA with a temperature and stirring profile intended to mimic a normal cooking process, as indicated in the following table:

The program for one incubation (20 minutes cooking profile) and viscosity measurement in RVA.

| Time | | | |
|---|---|---|---|
| [h:m:s] | Parameter | Value | |
| 00:00:00 | Temp | 20° | C. |
| 00:00:00 | Speed | 100 | rpm |
| 00:02:00 | Temp | 20° | C. |
| 00:22:00 | Temp | 96° | C. |
| 00:27:00 | Temp | 96° | C. |
| 00:37:00 | Temp | 45° | C. |
| 00:37:01 | Speed | 10 | rpm |
| 01:07:00 | Temp | 45° | C. |
| 01:07:10 | End | | |

### Example 6

### Dose-Response Relationship of Amylases in CSB+

In this Example, the effect of enzymes CSB+ porridge was explored. The amount of CSB+ powder was adapted to the enzyme dosage, with the aim of producing high-strength porridges with an acceptable viscosity profile.

CSB+
20′ profile

| | | | viscosity | viscosity at |
|---|---|---|---|---|
| | | Enzyme | end of | consumption |
| | CSB+ % | mg/g | boiling cP | cP |
| Blank | 13.8 | | 1500 | 7000 |
| Bacterial Amylase 51400 | 20.7 | 0.05 | 325 | 6000 |
| | 27.6 | 0.1 | 600 | 6000 |
| | 35.0 | 0.3 | 1100 | 7000 |
| Bakezyme P500 | 27.6 | 0.1 | 5000 | 30000 |
| | 27.6 | 0.5 | 3000 | 30000 |
| | 27.6 | 5 | 1500 | 10000 |

With CSB+, Bacterial Amylase 51400 gave a much better performance than Bakezyme P500.

### Example 7

### Synergy Between α-amylase and Amyloglucosidase in CSB+

In this example, it was explored whether the liberation of glucose in a 13.8% CSB+ porridge could be improved by combining α-amylase and amyloglucosidase.

CSB+ 13.8%
20′ profile

| | Enzyme mg/g | glucose (mg/g) |
|---|---|---|
| Blank | | 0 |
| Bacterial Amylase 51400 | 0.1 | 0 |
| Glucoamylase 65000 | 1.0 | 4.4 |
| Bacterial Amylase 51400 + | 0.1 + 1.0 | 8.1 |
| Glucoamylase 65000 | | |

It is clear that inclusion of the α-amylase Bacterial Amylase 51400 stimulated glucose production by the amyloglucosidase Glucoamylase 65000.

To further check how much glucose could be produced by the Glucoamylase 65000, the CSB+ concentration was increased to 35%, and the dosage of Bacterial Amylase 51400 was increased correspondingly (0.3 mg/g). In this system the following glucose levels were reached by increasing amounts of Glucoamylase 65000:

| | | |
|---|---|---|
| CSB+ 35% | + BAN800 | 0.3 mg/g |

20′ profile

| | Enzyme mg/g | glucose (mg/g) |
|---|---|---|
| Blank | | 0 |
| Glucoamylase 65000 | 1 | 28 |
| | 5 | 67 |
| | 7.5 | 76 |
| | 10 | 84 |
| | 15 | 93 |

### Example 8

### Synergy Between Amylases and Cellulase in CSB+

CSB+ powder is prepared using whole soy beans. Therefore a significant amount of fiber is present in the powder. In this example it is investigated whether a cellulase preparation can give an additional reduction in viscosity of CSB+ porridge.

CSB+
20′ profile

| | | | viscosity | |
|---|---|---|---|---|
| | | | end of | viscosity at |
| | | Enzyme | boiling | consumption |
| | CSB+ % | mg/g | cP | cP |
| Blank | 13.8 | | 1500 | 7000 |
| Bacterial Amylase | 20.7 | 0.05 | 325 | 6000 |
| 51400 | | | | |
| Bacterial Amylase | 20.7 | 0.05 + 10 | 400 | 4000 |
| 51400 + BGF cellulase | | | | |

The data show that the cellulose BGF preparation was able to give an additional viscosity reduction of the CSB+ porridge over the effect achieved with Bacterial Amylase 51400.

### Example 9

### Increasing the Dry Matter Content at Constant Enzyme Levels

To explore how viscosity and glucose production vary as a function of the CSB+ level, porridges with different CSB+ dry matter contents were incubated with a constant dose of 0.05 mg/g Bacterial Amylase 51400 and 1 mg/g Glucoamylase 65000. The enzyme dose was chosen to achieve a measureable viscosity over a wide range of dry matter contents, and does not directly reflect the optimal dosage for application.

CSB+
20′ profile

| | | viscosity end | viscosity at | glucose |
|---|---|---|---|---|
| | CSB+ % | of boiling cP | consumption cP | (mg/g) |
| Blank | 13.8 | 1500 | 7000 | 0 |
| Enzyme mix | 20 | 280 | 500 | 13 |
| | 25 | 550 | 2100 | 17 |
| | 30 | 1800 | 19000 | 20 |
| | 35 | 2000 | 60000 | 23 |

### Example 10

### Unfortified CSB

In this example, an unfortified CSB powder was used, to check the robustness of the enzyme application in the absence of potentially interfering minerals and vitamins.

CSB
20′ profile

| | | | viscosity | viscosity at |
|---|---|---|---|---|
| | CSB | Addition | end of | consumption |
| | % | mg/g | boiling cP | cP |
| Blank | 13.8 | | 2000 | 20000 |
| Bacterial Amylase 51400 | 27.6 | 0.1 | 2200 | 100000 |
| Bacterial Amylase 51400 + | 27.6 | 0.05 + 1.0 | 4000 | 200000 |
| Glucoamylase 65000 | | | | |
| Bacterial Amylase 51400 + | 27.6 | 0.1 + 8.0 | 350 | 3800 |
| CaCl₂•2H₂O | | | | |

The results show that the Bacterial Amylase 51400 was not capable of reducing the viscosity of double-strength CSB-porridge to the reference level of the single-strength recipe, unless calcium was added as well.

This was also investigated using the Bostwick test. In this test a fixed amount of substance is allowed to flow for a fixed period of time, and the maximal distance covered is recorded. Hence, a higher number implies a less solid substance. The CSB concentration was lowered slightly, to allow a reasonable flow of the reference material without enzymes.

CSB
Bostwick test

| | | | Bostwick |
|---|---|---|---|
| | | | Number |
| | CSB % | Addition mg/g | cm/30″ |
| Blank | 10 | | 9.50 |
| Bacterial Amylase 51400 + | 20 | 0.05 + 1.0 | 2.75 |
| Glucoamylase 65000 | | | |
| Bacterial Amylase 51400 + | 20 | 0.05 + 1.0 + 8.0 | 12.25 |
| Glucoamylase 65000 + | | | |
| CaCl₂•2H₂O | | | |

Again it was found that calcium was required to allow a good action of the enzymes.

### Example 11

### Taste of CBS++

Besides the viscosity, taste is another important parameter determining how much porridge one will consume. Therefore, a sensory taste of CSB++ porridge was performed, in single strength (reference) and double-strength recipes.

TABLE 8
Results from sensory taste.

| | CSB++ | | Enzyme | |
|---|---|---|---|---|
| | content | | dosage | |
| Nr. | [%] | Enzyme | [mg/g] | Description |
| 1 | 13.8 | — | — | Flowable |
| | | | | Very slight sweet |
| | | | | Slightly bitter |
| 2 | 27.6 | — | — | Very thick |
| | | | | Very slight sweet |
| | | | | Slightly bitter |
| 3 | 27.6 | Bacterial Amylase | 0.05 | Flowable |
| | | 51400 | | Very slight sweet |
| | | Glucoamylase 65000 | 0 | Slightly bitter |
| 4 | 27.6 | Bacterial Amylase | 0 | A little bit thinner than |
| | | 51400 | | Nr. 2 |
| | | | | Sweetness higher than |
| | | | | Nr. 2, lower than Nr. 5 |
| | | Glucoamylase 65000 | 1 | Not bitter |
| 5 | 27.6 | Bacterial Amylase | 0.05 | Flowable |
| | | 51400 | | Slightly sweet |
| | | Glucoamylase 65000 | 1 | Not bitter |

The enzyme treated double strength recipes were clearly preferable to the reference recipe in sensory aspects, in addition to their superior nutritional value.

1. A vitamin, mineral and enzyme premix for a fortified food blend comprising at least an alpha-amylase and a glucoamylase, wherein the alpha-amylase/glucoamylase enzyme unit ratio is comprised between 1/2 and 1/75.

2. A vitamin, mineral and enzyme premix according to claim 1, wherein the fortified food blend is a blend of cereal and legume flours, a corn soya blend, or a wheat soya blend.

3. A vitamin, mineral and enzyme premix according to claim 1, wherein the fortified food blend is a corn soya blend or a wheat soya blend.

4. A vitamin, mineral and enzyme premix according to claim 1, wherein the alpha-amylase/glucoamylase weight ratio is comprised between 1/1 and 1/50.

5. A vitamin, mineral and enzyme premix according to claim 1, wherein the premix comprises between 300 and 700 g alpha-amylase and glucoamylase per kg premix.

6. A vitamin, mineral and enzyme premix according to claim 1, wherein the premix comprises between 1000 and 5000 alpha-amylase units and between 10000 and 150000 glucoamylase units per kg premix.

7. A vitamin, mineral and enzyme premix according to claim 1, wherein the premix comprises between 300 and 700 g alpha-amylase and glucoamylase per kg premix, and the alpha-amylase/glucoamylase unit ratio in comprised between 1/2 and 1/75.

8. Use of a premix according to claim 1 in a fortified food blend for the preparation of porridge, wherein the energy density of the porridge is greater than 800 kcal/l, and the viscosity at 45° C., as measured in a Bostwick test is greater than 10 cm/30″.

9. Fortified food blend comprising a premix according to claim 1 for the preparation of a tasty porridge, wherein the energy density of the porridge is greater than 800 kcal/l, and the viscosity at 45° C., as measured in a Bostwick test, is greater than 10 cm/30″.

10. A fortified food blend according to claim 9, wherein the fortified food blend is a corn soya blend or a wheat soya blend.

11. A fortified food blend according to claim 10, wherein the energy density of the porridge is greater than 1000 kcal/l, and the viscosity at 45° C., as measured in a Bostwick test, is greater than 10 cm/30″.

12. A fortified food blend according to claim 9, wherein the energy density of the porridge is greater than 1200 kcal/l, and the viscosity at 45°, as measured in a Bostwick test, is greater than 10 cm/30″.

13. A fortified food blend according to claim 9, wherein the energy density of the porridge is greater than 1000 kcal/l, and the viscosity at 45° C., as measured in a Bostwick test, is greater than 12 cm/30″.

14. Porridge prepared from a fortified food blend, according to claim 9, wherein the energy density of the porridge is greater than 800 kcal/l, and the viscosity at 45° C., as measured in a Bostwick test, is greater than 10 cm/30″.
